(19) United States
(12) Patent Application Publication
(10) Pub. No.: US 2011/0255948 A1
(43) Pub. Date: Oct. 20, 2011

(54) Suction Device

(76) Inventor: Mark A. Malinowski, Excelsior, MN (US)

(21) Appl. No.: 13/080,455

(22) Filed: Apr. 5, 2011

Related U.S. Application Data
(60) Provisional application No. 61/325,718, filed on Apr. 19, 2010.

(51) Int. Cl. B25J 15/06; B25J 1/00

(52) U.S. Cl. 414/800; 294/64.2

(57) ABSTRACT

A suction device includes a handle assembly, a tube and a suction cup. The handle assembly includes a body defining a Venturi vacuum generator. The Venturi vacuum generator includes an inlet passage, an outlet passage and a valve bore. The inlet passage includes an inlet port. The outlet passage includes an outlet port and a suction port. A valve is disposed in the valve bore of the body. The valve provides selective fluid communication between the inlet passage and the outlet passage. An actuator is engaged to the body. The actuator is adapted to actuate the valve. The tube has a first axial end and an oppositely disposed second axial end. The first axial end is engaged to the handle assembly. The suction cup is engaged to the second axial end of the tube.

### CROSS-REFERENCE TO RELATED APPLICATION

This application claims priority to U.S. Provisional Application Ser. No. 61/325,718, filed on Apr. 19, 2010, titled SUCTION DEVICE, by Mark Malinowski, the disclosure of which is hereby incorporated by reference in its entirety.

### BACKGROUND

Many products are manufactured using an assembly line process. Conveyor systems are often used in assembly lines to move products from one work location to another. When damaged products or products not meeting quality standards of the manufacturer are discovered on the conveyor system, these products must be removed from the conveyor system before being sent to the subsequent work location along the assembly line.

In some manufacturing facilities, assembly line workers must reach across the conveyor system to grab the damaged product from the assembly line. However, such action can result in injury to the worker and/or damage to the conveyor system. Such injury and or damage can result in loss of production yield for the manufacturer and loss of revenue.

### SUMMARY

An aspect of the present disclosure relates to a suction device. The suction device includes a handle assembly, a tube and a suction cup. The handle assembly includes a body defining a Venturi vacuum generator. The Venturi vacuum generator includes an inlet passage, an outlet passage and a valve bore. The inlet passage includes an inlet port. The outlet passage includes an outlet port and a suction port. A valve is disposed in the valve bore of the body. The valve provides selective fluid communication between the inlet passage and the outlet passage. An actuator is engaged to the body. The actuator is adapted to actuate the valve. The tube has a first axial end and an oppositely disposed second axial end. The first axial end is engaged to the handle assembly. The suction cup is engaged to the second axial end of the tube.

Another aspect of the present disclosure relates to a suction device. The suction device includes a handle assembly, a tube and a suction cup. The handle assembly includes a body defining a Venturi vacuum generator. The Venturi vacuum generator includes an inlet passage, an outlet passage and a valve bore. The inlet and outlet passages are in fluid communication with the valve bore. The inlet passage includes an inlet port that is adapted for engagement to a source of pressurized air. The outlet passage includes an outlet port and a suction port. A valve is disposed in the valve bore of the body. The valve provides selective fluid communication between the inlet passage and the outlet passage. An actuator includes a base end and a free end. The base end is pivotally engaged to the body. The free end of the actuator is adapted to actuate the valve. The tube has a first axial end and an oppositely disposed second axial end. The first axial end is engaged to the suction port of the handle assembly. The suction cup is engaged to the second axial end of the tube.

Another aspect of the present disclosure relates to a method of using a suction device. The method includes providing a suction device. The suction device includes a handle assembly having a body and an actuator. The body defines a Venturi vacuum generator. The actuator is engaged to the body. The actuator is adapted to actuate the Venturi vacuum generator. The suction device further includes a tube engaged to the handle assembly and a suction cup engaged to the tube. An object to be removed from a surface is identified. The suction device is oriented so that an end of the suction cup is disposed adjacent to the object. The actuator is actuated to activate the Venturi vacuum generator. The object is lifted from the surface with the suction device. The object is moved with the suction device. The actuator is actuated to deactivate the Venturi vacuum generator.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is an exploded isometric view of a suction device having exemplary features of aspects in accordance with the principles of the present disclosure.

FIG. 2 is an alternate exploded isometric view of the suction device of FIG. 1.

FIG. 3 is an exploded isometric view of a handle assembly suitable for use with the suction device of FIG. 1.

FIG. 4 is a top view of the handle assembly of FIG. 3.

FIG. 5 is a cross-sectional view of the handle assembly taken on multiple planes to show a Venturi vacuum generator.

FIG. 6 is a cross-sectional view of the handle assembly taken on line 6-6 of FIG. 5.

FIG. 7 is a cross-section view of the handle assembly taken on line 7-7 of FIG. 5.

FIG. 8 is a cross-sectional view of the handle assembly taken on line 8-8 of FIG. 5.

FIG. 9 is a representation of a method of using the suction device of FIG. 1.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

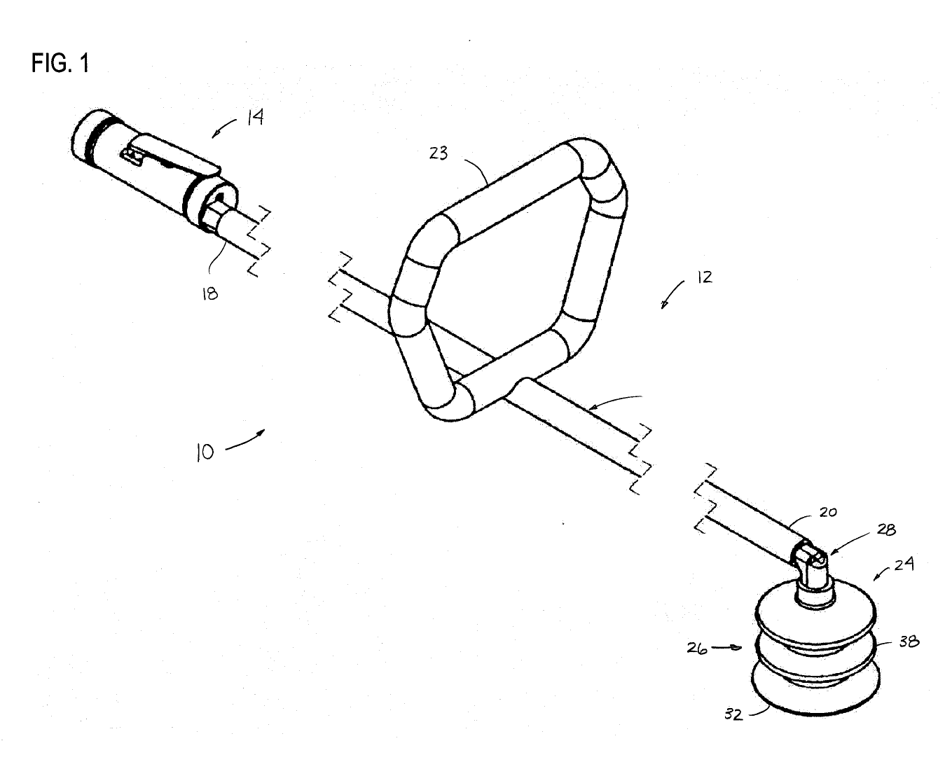

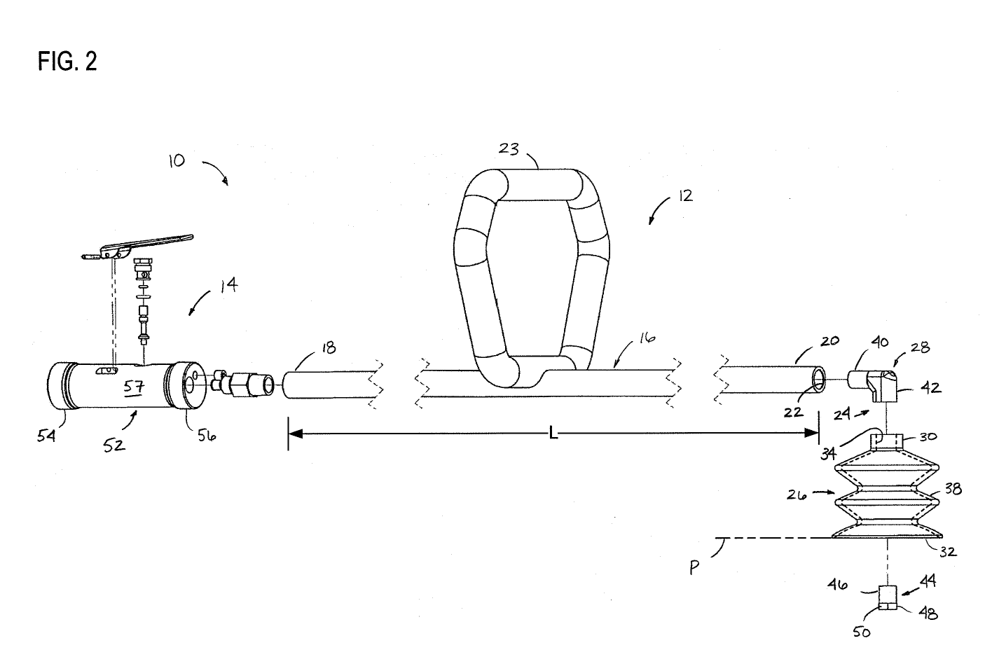

Referring now to FIGS. 1 and 2, a suction device 10 is shown. The suction device 10 of the present disclosure is adapted to selectively pickup objects and to place those objects at a user defined location. The suction device 10 includes a tube assembly 12 and a handle assembly 14.

The tube assembly 12 includes a tube 16 having a first axial end 18 and an oppositely disposed second axial end 20. The tube 16 defines a bore 22 that extends through the first and second axial ends 18, 20. In one embodiment, a length L of the tube 16 measured between the first axial end 18 and the second axial end 20 is less than or equal to about 8 feet. In another embodiment, the length L is less than or equal to about 7 feet. In another embodiment, the length L is less than or equal to about 5 feet.

In the depicted embodiment, the tube 16 is an aluminum tube having a generally cylindrical shape. In one embodiment, the tube 16 has an outer diameter that is less than or equal to about 2.5 inches. In another embodiment, the outer diameter of the tube 16 is less than or equal to about 2 inches. In another embodiment, the outer diameter of the tube 16 is less than or equal to about 1 inch. In another embodiment, the outer diameter of the tube 16 is in the range of about 0.5 inches to about 2.5 inches. In another embodiment, the outer diameter of the tube 16 is in the range of about 0.5 inches to about 1 inch.

The tube assembly 12 includes a handle grip 23. In the depicted embodiment, the handle grip 23 is disposed between the first and second axial ends 18, 20 of the tube 16. The handle grip 23 is adapted to provide a location at which the suction device 10 can be stabilized by the user during use. In one embodiment, the handle grip 23 is a continuous loop that is fastened (e.g., screwed, adhered, etc.) to the tube 16.

The tube assembly 12 includes a suction cup assembly 24 disposed at the second axial end 20 of the tube 16. The suction cup assembly 24 includes a suction cup 26 and a fitting 28.

The suction cup 26 includes a first end 30 and an oppositely disposed second end 32. The suction cup 26 defines a passage 34 (shown as a dashed line in FIG. 2) that extends through the first and second ends 30, 32 of the suction cup 26. The suction cup 26 defines a central axis 36 that extends through the first end 30. The second end 32 is disposed in a plane P (shown as a dashed line in FIG. 2) that is generally perpendicular to the central axis 36 when the suction cup 26 is not engaged to an object.

In the depicted embodiment, the suction cup 26 includes a plurality of baffles 38. The baffles 38 are adapted to allow movement of the second end 32 of the suction cup 26 relative to the first end 30. In one embodiment, the baffles 38 allow suction cup 26 to compress in an axial direction so that the second end 32 is closer to the first end 30. In another embodiment, the baffles 38 allow the second end 32 to be oriented relative to the first end 30 so that the plane P is disposed at an oblique angle relative to the central axis 36.

The fitting 28 is adapted to provide engagement between the tube 16 and the suction cup 26. The fitting 28 includes a first end portion 40 and a second end portion 42. The fitting 28 defines a thru-bore that extends through the first and second end portions 40, 42. In the depicted embodiment, the second end portion 42 is generally perpendicular to the first end portion 40.

The first end portion 40 is adapted for engagement with the second end 20 of the tube 16 so that the thru-bore of the fitting 28 is in communication with the bore 22 of the tube 16. In one embodiment, the first end portion 40 includes a plurality of external threads that is adapted for threaded engagement with a plurality of internal threads disposed in the bore 22 at the second axial end 20 of the tube 16.

The second end portion 42 of the fitting 28 is adapted for engagement with the suction cup 26 so that the thru-bore of the fitting 28 is in communication with the passage 34 of the suction cup 26. In one embodiment, the second end portion 42 includes a plurality of internal threads.

A fastener 44 is adapted to engage the suction cup 26 to the fitting 28. The fastener 44 is disposed in the passage 34 of the suction cup 26. The fastener 44 includes a first axial end portion 46 and an oppositely disposed second axial end portion 48. The first axial end portion 46 includes the external threads that are adapted for engagement with the internal threads of the fitting 28. The second axial end portion 48 includes a flange 50 that extends radially outward. The flange 50 is adapted to engage the first end 30 of the suction cup 26 so that the first end 30 of the suction cup 26 is retained between the second end portion 42 of the fitting and the flange 50 of the fastener 44. The fastener 44 defines a thru-passage that is in communication with the thru-bore of the fitting 28.

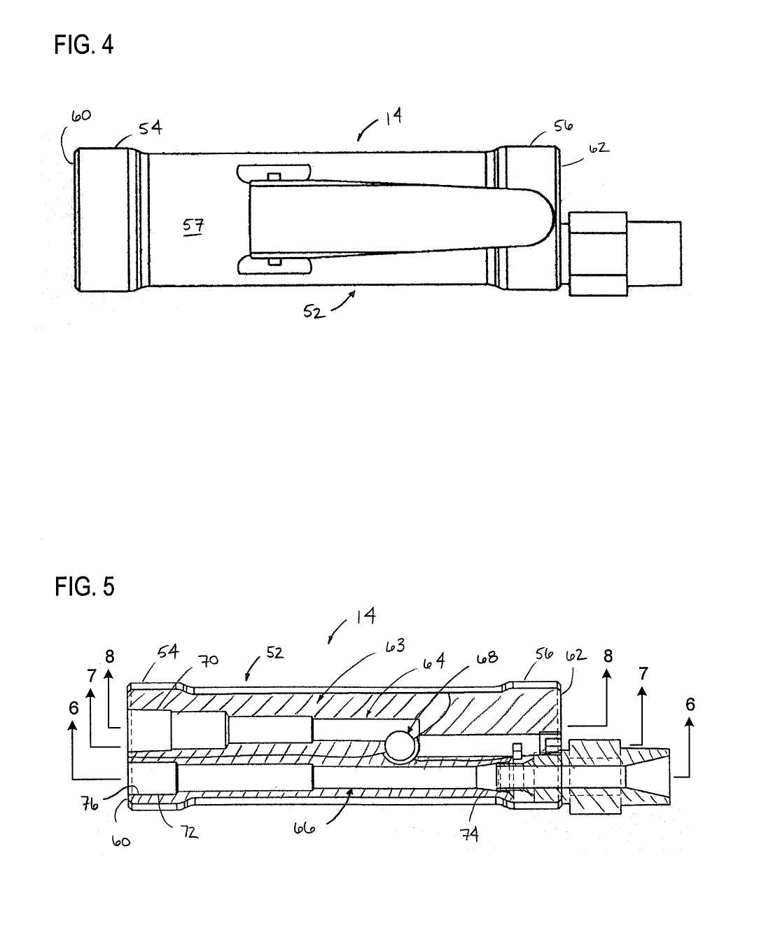

Referring now to FIGS. 2-4, the handle assembly 14 is shown. The handle assembly 14 is engaged to the first axial end 18 of the tube 16. The handle assembly 14 includes a body 52. The body 52 is sized and configured so that the body 52 can be grasped by a user of the suction device 10. In the depicted embodiment, the body 52 is cylindrical in shape.

The body 52 includes a gripping portion 53, a first end 54, and an oppositely disposed second end 56. The gripping portion 53 is disposed between the first and second ends 54, 56. In the depicted embodiment, the first and second ends 54, 56 have outer diameters that are greater than the outer diameter of the gripping portion 53.

The body 52 includes an outer surface 57 that extends between the first and second ends 54, 56. The body 52 defines a central longitudinal axis 58 that extends through the first and second ends 54, 56 of the body 52. The first end 54 includes a first end surface 60 while the second end 56 includes a second end surface 62. In the depicted embodiment, the first and second end surfaces 60, 62 are generally parallel. In the depicted embodiment, the first and second end surface 60, 62 are generally perpendicular to the central longitudinal axis 58.

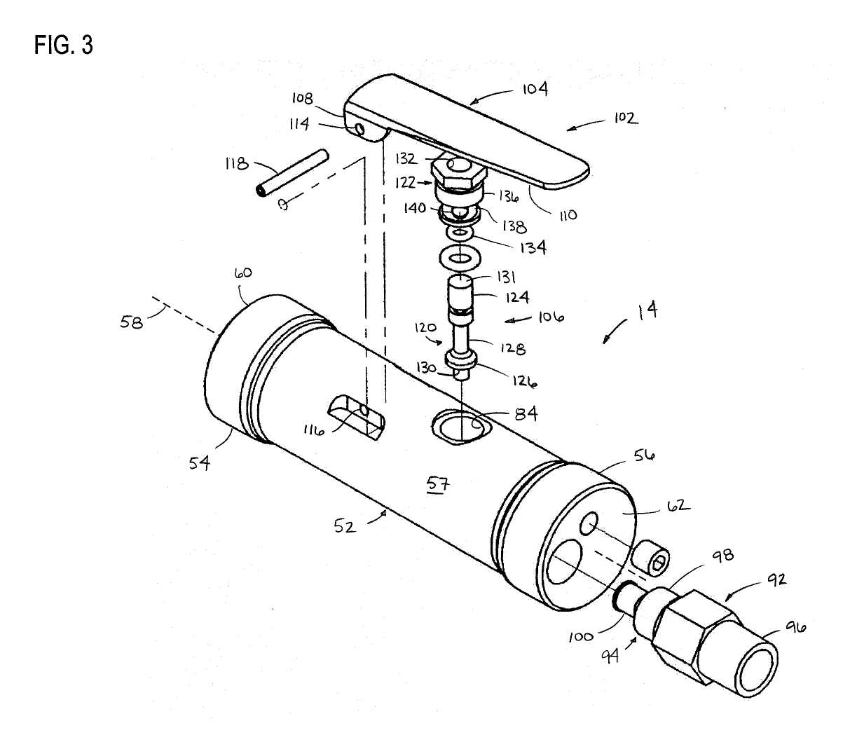

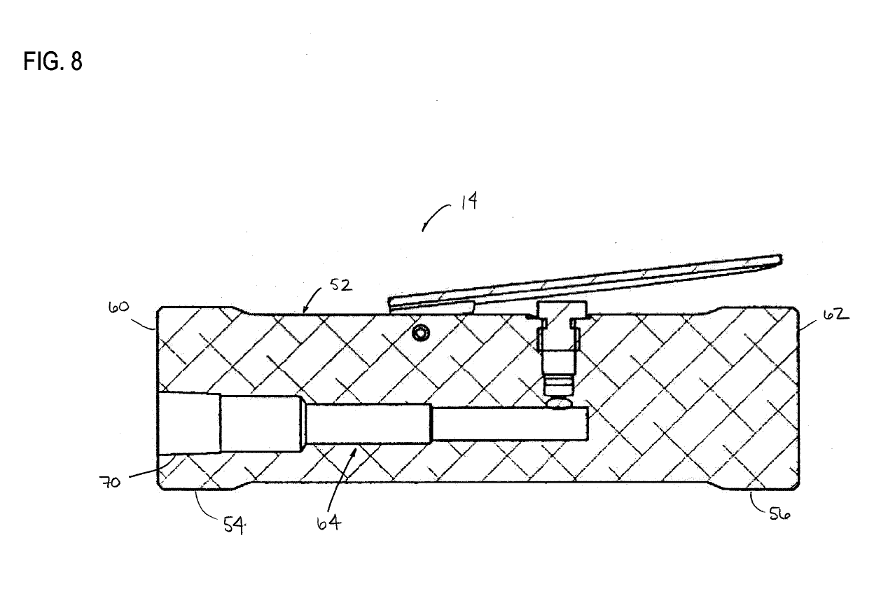

Referring now to FIGS. 3 and 5-8, the body 52 further defines a Venturi vacuum generator 63. The Venturi vacuum generator 63 of the body 52 is adapted to draw a vacuum using the Venturi effect. The Venturi vacuum generator 63 includes a plurality of passages. The body 52 defines an inlet passage 64, an outlet passage 66, and a valve bore 68.

In the depicted embodiment, the inlet passage 64 extends into the body 52 in a direction that is generally parallel to the central longitudinal axis 58. The inlet passage 64 includes an inlet port 70. The inlet port 70 is defined by the first end surface 60 and is adapted for engagement to a source of pressurized air. In one embodiment, the inlet port 70 includes internal threads that are adapted for threaded engagement with external threads disposed on an end of an air hose or tube, which is in communication with the source of pressurized air.

The outlet passage 66 extends through the body 52. In the depicted embodiment, the outlet passage 66 extends through the body 52 in a direction that is generally parallel to the central longitudinal axis 58 and the inlet passage 64.

The outlet passage 66 includes an outlet port 72 and an oppositely disposed suction port 74. The outlet port 72 is defined by the first end 54 while the suction port 74 is defined by the second end 56. The outlet port 72 of the outlet passage 66 includes a first opening 76 defined by the first end surface 60 of the first end 54. The suction port 74 includes a second opening 78 (shown in FIG. 3) defined by the second end surface 62 of the second end 56.

In the depicted embodiment, the valve bore 68 is generally perpendicular to the central longitudinal axis 58 of the body 52. The valve bore 68 is adapted to provide selective fluid communication between the inlet passage 64 and the outlet passage 66.

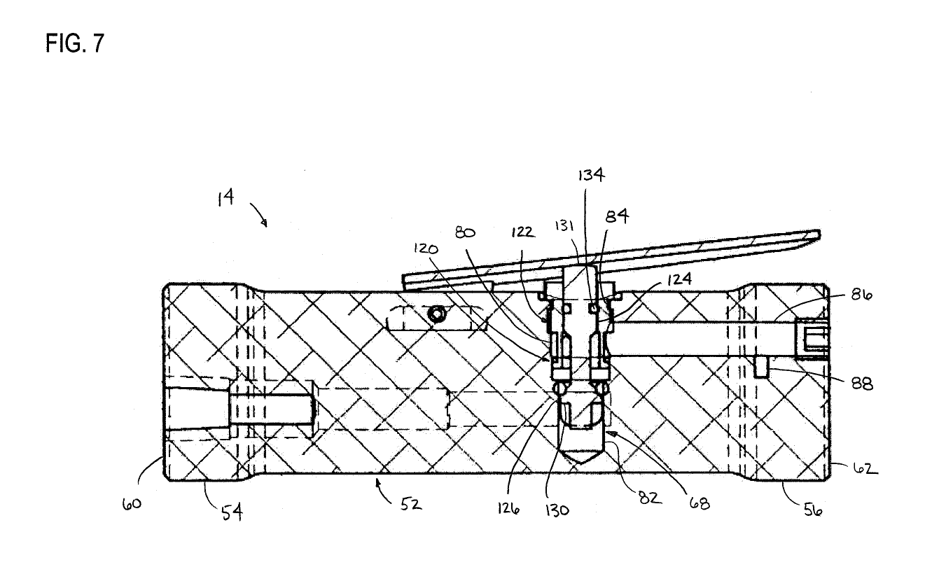

The valve bore 68 includes a first axial end portion 80 (shown in FIG. 7) and an oppositely disposed second axial end portion 82 (shown in FIG. 7). The first axial end portion 80 of the valve bore 68 includes an opening 84 to the valve bore 68 that extends through the outer surface 57 of the body 52.

The second axial end portion 82 of the valve bore 68 is in fluid communication with the inlet passage 64. In the depicted embodiment, the inlet passage 64 of the body 52 intersects the second axial end portion 82.

The first axial end portion 80 of the valve bore 68 is in fluid communication with the outlet passage 66. In the depicted embodiment, a connection passage 86 provides fluid communication between the first axial end portion 80 of the valve bore 68 and the outlet passage 66. The connection passage 86 intersects the first axial end portion 80 of the valve bore 68. The connection passage 86 is in communication with the outlet passage 66 through a pathway 88 that intersects the outlet passage 66 at a location adjacent to the suction port 74.

In the depicted embodiment, the connection passage 86 provides a flow constriction in body 52. This flow constriction causes the velocity of the air flowing through the outlet passage 66 to be greater than the velocity of air flowing through the inlet passage 64.

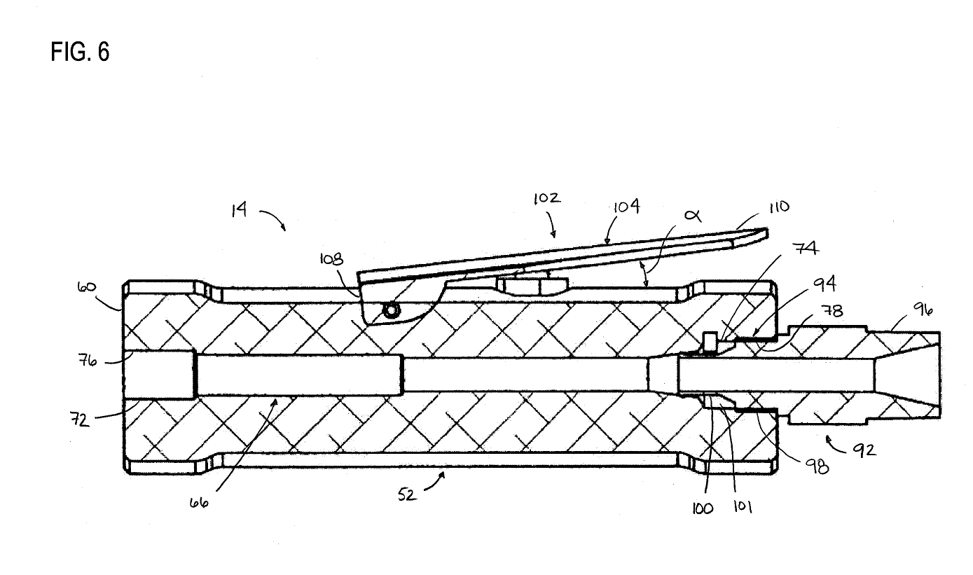

Referring now to FIGS. 3 and 6, the Venturi vacuum generator 63 further includes a fitting 92. The fitting 92 is adapted to provide engagement between the tube 16 and the body 52. The fitting 92 includes a first end section 94 and an oppositely disposed second end section 96. The first end section 94 is adapted for engagement with the suction port 74 of the body 52.

The first end section 94 includes a connection portion 98 and an end projection 100. In one embodiment, the connection portion 98 includes a plurality of external threads that is adapted for engagement with a plurality of internal threads in the suction port 74.

The end projection 100 has an outer diameter that is less than the outer diameter of the connection portion 98. In the depicted embodiment, the end projection 100 has an outer diameter that is less than an inner diameter of the outlet passage 66. When the connection portion 98 is engaged to the suction port 74 of the body 52, the end projection 100 overlaps the pathway 88 so that air passing through the connection passage 86 enters a space 101 between the outlet passage 66 and the end projection 100 of the fitting 92 and is directed toward the outlet port 72.

Referring now to FIGS. 3, 4 and 7, the handle assembly 14 further includes an actuator assembly 102. The actuator assembly 102 is disposed between the first and second ends 54, 56 of the body 52 of the handle assembly 14. The actuator assembly 102 includes an actuator 104 and a valve assembly 106.

In the depicted embodiment, the actuator 104 is a lever. The actuator 104 includes a base end 108 and a free end 110. The base end 108 is pivotally engaged to the body 52. The base end 108 defines an opening 114. The opening 114 is adapted for alignment with a hole 116 disposed in the body 52. In the depicted embodiment, a pin member 118 is disposed in the opening 114 of the actuator 104 and the hole 116 of the body 52 to engage the base end 108 of the actuator 104 to the body 52. The base end 108 of the actuator 104 selectively pivots about the pin member 118 between a first position (e.g., an “off” position) and a second position (e.g., an “on” position).

The free end 110 extends outwardly from the base end 108 of the actuator 104. The free end 110 extends outwardly from the base end 108 in a direction that is generally along the central longitudinal axis 58. In one embodiment, the free end 110 is generally parallel to the central longitudinal axis 58 of the body 52 when the actuator 104 is in the first position. In the depicted embodiment, the free end 110 is disposed at an angle α (shown in FIG. 6) relative to the central longitudinal axis 58 when the actuator 104 is in the first position. In one embodiment, the angle α is an oblique angle. In another embodiment, the angle α is less than or equal to about 45 degrees.

The valve assembly 106 is disposed in the valve bore 68 defined by the body 52. The valve assembly 106 includes a valve 120 and a sleeve 122 that is disposed around a portion of the valve 120.

The valve 120 includes a first end portion 124 and an oppositely disposed second end portion 126. The valve 120 defines a circumferential groove 128 that extends between the first and second end portions 124, 126.

The valve 120 is disposed in the valve bore 68 so that the second end portion 126 of the valve 120 is adjacent the second axial end portion 82 of the valve bore 68. The second end portion 126 includes a spring seat 130. In one embodiment, a spring is disposed in the valve bore 68 so that a first end of the spring abuts the spring seat 130 of the valve 120 while an opposite second end of the spring abuts the second axial end portion 82 of the valve bore 68. The spring is adapted to bias the valve 120 to a closed position (shown in FIG. 7).

In the depicted embodiment, an end 131 of the first end portion 124 extends outwardly from the opening 84 of the body 52. The end 131 is adapted to engage the free end 110 of the actuator 104. In the depicted embodiment, the end 131 is arcuate in shape. In another embodiment, the end 131 includes a radius.

The sleeve 122 defines a central bore 132 that extends through the sleeve 122 in an axial direction. The central bore 132 is adapted to receive the first end portion 124 of the valve 120. The first end portion 124 of the valve 120 and the central bore 132 are in sliding engagement. In order to reduce or prevent fluid leakage between the first end portion 124 of the valve 120 and the central bore 132 of the sleeve 122, an o-ring 134 is disposed in a groove of the first end portion 124 of the valve 120.

The sleeve 122 includes an outer surface 136 that defines a channel 138 that extends circumferentially about the sleeve 122. The sleeve 122 further defines a plurality of passages 140 that extend through the channel 138. The passages 140 provide fluid communication between the central bore 132 of the sleeve 122 and the channel 138.

Referring now to FIGS. 1-3 and 7, the actuation of the actuator assembly 102 will be described. With the actuator 104 in the closed position (shown in FIG. 7), the valve 120 blocks fluid communication between the inlet passage 64 of the body 52 and the outlet passage 66. When the free end 110 of the actuator 104 is depressed, the free end 110 acts against the first end portion 124 of the valve 120 so that the valve 120 compresses the spring disposed in the valve bore 68. As the actuator 104 is depressed, air in the inlet passage 64 is communicated to the outlet passage 66 through the valve bore 68.

With the actuator 104 depressed, air flows from the inlet passage 64 to the connection passage 86. Air passes through the pathway 88 into the outlet passage 66. In the outlet passage 66, air is directed to the outlet port 72. As previously provided, the velocity of the air in the outlet passage 66 is greater than the velocity of the air in the inlet passage 64 due to the flow constriction in the body 52 between the inlet and outlet passages 64, 66. In the depicted embodiment, a vacuum is generated at the suction port 74 due to the passage of pressurized air through the Venturi vacuum generator 63 of the body 52.

Air is drawn into the suction port 74 through the suction cup 26 and the tube 16. Air that is drawn into the suction port 74 is exhausted through the outlet port 72 of the body 52. The air that is drawn into the suction port 74 creates suction at the second end 32 of the suction cup 26. This suction is used to grasp an object.

When the actuator 104 is released, the spring biases the valve 120 to the closed position. In the closed position, the valve blocks fluid communication between the inlet passage 64 and the outlet passage 66. In one embodiment, the object held by the suction cup 26 is released when the actuator 104 is released.

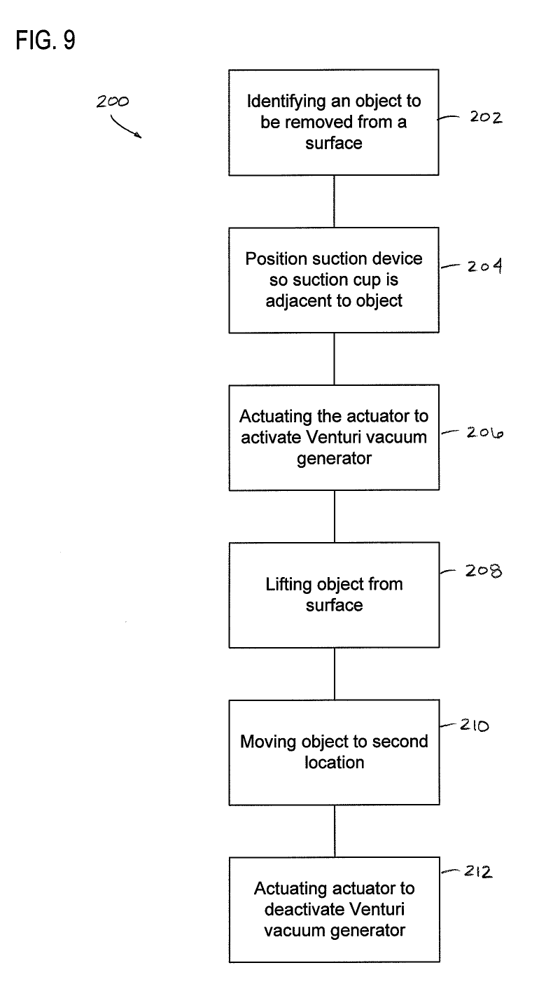

Referring now to FIGS. 1 and 9, a method 200 of using the suction device 10 will be described. In one embodiment, the suction device 10 is used to remove damaged objects (e.g., products or items) from a surface (e.g., conveyor-type system, a conveyor belt, etc.). In one embodiment, the object is a paperboard product (e.g., cardboard, corrugated board, etc.).

In operation 202, the damaged object is identified. In one embodiment, the damaged object is identified as the object is transported via the conveyor system from one location to another location. In operation 204, the suction device 10 is oriented so that the second end 32 of the suction cup 26 of the suction device 10 is disposed adjacent to a surface of the damaged object. The suction device 10 is positioned so that the second end 32 of the suction cup 26 contacts the surface of the object to be removed from the conveyor system.

With the suction cup 26 contacting the surface of the object, the actuator 104 is actuated in operation 206. In one embodiment, the free end 110 of the actuator 104 is depressed so that the valve 120 is actuated to an open position. With the valve 120 in the open position, a vacuum is drawn through the tube 16 and the suction cup 26. The suction drawn through the suction cup 26 is strong enough to hold the object to be removed from the conveyor system.

In operation 208, the object is lifted from the conveyor system using the suction device 10. With the object lifted from the conveyor, the object can be moved to a second location (e.g., a discard location, rework location, etc.) using the suction device 10 in operation 210.

In operation 212, the actuator 104 is actuated so that the valve 120 is in the closed position. In the depicted embodiment, the actuator 104 is released and a spring biases the valve 120 to the closed position. With the actuator 104 released, the object is released from the second end 32 of the suction cup 26.

The suction device 10 can also be used for a wide variety of other applications. For example, the suction device 10 can be used to remove sheet metal parts from a stamping machine. As another example, the suction device 10 is used to remove a sample piece or product from a manufacturing line. The sample can then be evaluated, such as to confirm that the sample meets certain quality criteria.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A suction device comprising:
a handle assembly including:
a body defining a Venturi vacuum generator, the Venturi vacuum generator including an inlet passage, an outlet passage and a valve bore, the inlet passage including an inlet port, the outlet passage including an outlet port and a suction port;
a valve disposed in the valve bore, the valve providing selective fluid communication between the inlet passage and the outlet passage;
an actuator engaged to the body, the actuator adapted to actuate the valve;
a tube having a first axial end and an oppositely disposed second axial end, the first axial end being engaged to the handle assembly; and
a suction cup being engaged to the second axial end of the tube.

2. The suction device of claim 1, wherein the actuator is pivotally engaged to the body.

3. The suction device of claim 1, wherein the suction cup includes a first end, an oppositely disposed second end and a plurality of baffles disposed between the first and second ends.

4. The suction device of claim 1, wherein the inlet and outlet passages are in fluid communication with the valve bore.

5. The suction device of claim 1, wherein the inlet port is adapted for engagement with a source of pressurized air.

6. The suction device of claim 1, wherein the body includes a first end surface and an oppositely disposed second end surface, the inlet and outlet ports being defined by the first end surface, the suction port being defined by the second end surface.

7. The suction device of claim 1, wherein the Venturi vacuum generator includes a connection passage that provides communication between the valve bore and the outlet passage.

8. The suction device of claim 1, wherein the tube includes a handle grip disposed between the first and second axial ends.

9. A suction device comprising:
a handle assembly including:
a body defining a Venturi vacuum generator, the Venturi vacuum generator including an inlet passage, an outlet passage and a valve bore, the inlet and outlet passages being in fluid communication with the valve bore, the inlet passage including an inlet port that is adapted for engagement with a source of pressurized air, the outlet passage including an outlet port and a suction port;
a valve disposed in the valve bore, the valve providing selective fluid communication between the inlet passage and the outlet passage;
an actuator having a base end and a free end, the base end being pivotally engaged to the body, the free end being adapted to actuate the valve;
a tube having a first axial end and an oppositely disposed second axial end, the first axial end being engaged to the suction port of the handle assembly; and
a suction cup being engaged to the second axial end of the tube.

10. The suction device of claim 9, wherein the tube includes a handle grip disposed between the first and second axial ends.

11. The suction device of claim 9, wherein the body includes a first end surface and an oppositely disposed second end surface, the inlet and outlet ports being defined by the first end surface, the suction port being defined by the second end surface.

12. The suction device of claim 9, wherein the suction cup includes a first end, an oppositely disposed second end and a plurality of baffles disposed between the first and second ends.

13. The suction device of claim 9, wherein a fitting engages the first axial end of the tube to the suction port of the body of the handle assembly.

14. The suction device of claim 13, wherein the body defines a connection passage that provides communication between the valve bore and the outlet passage.

15. The suction device of claim 14, wherein the fitting includes an end projection portion that overlaps a pathway between the outlet passage and the connection passage.

16. A method of using a suction device comprising:
providing a suction device having:
a handle assembly including:
a body defining a Venturi vacuum generator;
an actuator engaged to the body, the actuator being adapted to actuate the Venturi vacuum generator;
a tube engaged to the handle assembly; and
a suction cup being engaged to the tube;
identifying an object to be removed from a surface;
orienting the suction device so that an end of the suction cup is disposed adjacent to the object;
actuating the actuator to activate the Venturi vacuum generator;
lifting the object from the surface with the suction device;
moving the object with the suction device; and
actuating the actuator to deactivate the Venturi vacuum generator.

17. The method of claim 16, wherein the surface from which the object is to be removed is a conveyor belt.

18. The method of claim 16, wherein the object is damaged.

19. The method of claim 16, wherein the Venturi vacuum generator includes an inlet passage, an outlet passage and a valve bore, the inlet and outlet passages being in fluid communication with the valve bore, the inlet passage including an inlet port that is adapted for engagement with a source of pressurized air, the outlet passage including an outlet port and a suction port.

20. The method of claim 16, wherein the object is a corrugated product.
